(19) United States
(12) Patent Application Publication
(10) Pub. No.: US 2004/0202185 A1
(43) Pub. Date: Oct. 14, 2004

(54) Multiple virtual local area network support for shared network adapters

(75) Inventors: Bruce H. Ratcliff, Red Hook, NY (US); Stephen R. Valley, Valatie, NY (US)

Correspondence Address: Floyd A. Gonzalez, IBM Corporation, 2455 South Road, P386, Poughkeepsie, NY, 12601, US

(73) Assignee: International Business Machines Corporation, Armonk, NY (US)

(21) Appl. No.: 10/413,618

(22) Filed: Apr. 14, 2003

(51) Int. Cl. H04L 12/28

(52) U.S. Cl. 370/395.53; 370/386

(57) ABSTRACT

A data processing system which includes a host computer having a memory partitioned into multiple logical partitions, each partition having an operating system for processing data, an adapter. The data processing system further includes multiple virtual local area networks (VLANs) for exchanging data with the partitions of the host computer. An Internet Protocol Assist (IPA) layer in the host computer assigns one or more Internet Protocol (IP) addresses to the partitions, and associates the IP addresses of the partitions with one or more VLANs such that data may be exchanges between an individual partition and one or VLANs in unicast, multicast or broadcast operations.

### TRADEMARKS

IBM® is a registered trademark of International Business Machines Corporation, Armonk, N.Y., U.S.A. S/390, zSeries, z/OS, z/VM and z990 and other names used herein may be registered trademarks, trademarks or product names of International Business Machines Corporation or other companies.

### BACKGROUND OF THE INVENTION

1. Field of the Invention

This invention relates to administration of logical groups of stations in Local Area Networks (LAN) and more particularly to correlating multiple Virtual Local Area Networks (VLAN) to an Internet Protocol (IP) address or set of IP addresses in a single or multipartitioned host environment.

2. Description of Background

The IEEE standard 802.1 Q describes the operation of Virtual LAN Bridges across a Bridged LAN. A Virtual Local Area Network (VLAN) is defined to be a subset of the active topology of a Bridged Local Area Network. Associated with each VLAN is a VLAN Identifier (VID). VLANs facilitate easy administration of logical groups of stations that can communicate as if they were on the same LAN. They also facilitate easier administration of moves, adds, and changes in members of these groups. Traffic between VLANs is restricted. Bridges forward unicast, multicast, and broadcast traffic only on LAN segments that serve the VLAN to which the traffic belongs.

U.S. Pat. No. 5,878,232 issued Mar. 2, 1999 to Marimuthu for DYNAMIC RECONFIGURATION OF NETWORK DEVICE'S VIRTUAL LANS USING THE ROOT IDENTIFIERS AND ROOT PORTS DETERMINED BY A SPANNING PROCEDURE discloses a system and method of configuring VLANs of a multiple port bridging device for allowing efficient routing of certain traffic across a network.

U.S. Pat. No. 5,968,126 issued Oct. 19, 1999 to Ekstrom et al. for USER-BASED BINDING OF NETWORK STATIONS TO BROADCAST DOMAINS and discloses a broadcast or multicast message from a network station which is forwarded to stations in the same virtual broadcast domain. In some embodiments a VLAN is used.

U.S. Pat. No. 6,061,334 issued May 9, 2000 to Berlovitch et al. for APPARATUS AND METHOD FOR ASSIGNING VIRTUAL LANS TO A SWITCHED NETWORK and discloses an apparatus for managing a switched routed network including a network configuration learning unit operative to learn a configuration of the switched routed network, and a VLAN assignment unit for generating a division of the network into virtual LANs.

U.S. Pat. No. 6,075,776 issued Jun. 13, 2000 to Tanimoto et al. for VLAN CONTROL SYSTEM AND METHOD and discloses a VLAN control system which includes a remote access server connected to a home network in the VLAN having a global network for controlling communication between any moved terminal and the home network.

U.S. Pat. No. 6,085,238 issued Jul. 4, 2000 to Yuasa et al. for VIRTUAL LAN SYSTEM and discloses a virtual LAN system having a virtual group which is based on elements having physical attributes or logical attributes with traffic shaping and the management of the LAN to increase overall bandwidth.

U.S. Pat. No. 6,157,647 issued Dec. 5, 2000 to Husak for DIRECT ADDRESSING BETWEEN VLAN SUBNETS and discloses a technique for more directly transmitting information between devices in different VLANs.

U.S. Pat. No. 6,167,052 issued Dec. 26, 2000 to McNeill et al. for ESTABLISHING CONNECTIVITY IN NETWORKS and discloses a network including a number of domains interconnected by routers. Within each domain, traffic is forwarded based on MAC addresses. The routers route traffic based on IP addresses or other network layer addresses.

U.S. Pat. No. 6,188,691 issued Feb. 13, 2001 to Barkai et al. for MULTICAST DOAMIN VIRTUAL LOCAL AREA NETWORK and discloses a method whereby local area network multicast traffic flows are defined and set up by a network management system.

U.S. Pat. No. 6,208,649 issued Mar. 27, 2001 to Kloth for DERIVED VLAN MAPPING TECHNIQUE and discloses a derived virtual local area network mapping technique which enables centralized control of broadcast domains by a switch capable of supporting different protocols carried within frames that are distributed throughout a computer internetwork.

### SUMMARY OF THE INVENTION

The present invention allows IBM S/390 Shared Network Attachments to effectively participate in and police VLAN activity coming from and going to a mainframe class server such as the IBM eServer zSeries model 990 server. This proposal provides a means to correlate multiple VLAN(s) to an IP address or a set of IP Addresses. In addition, it provides some general rules on how to manage the transmitting and receiving of such packets belonging to a VLAN. It can also be used to manage traffic flow policies by allowing certain IP addresses to be restricted to only certain VLAN(s).

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings.

FIG. 1 is a schematic diagram of a data processing system including the present invention having a Central Electric Complex (CEC) having multiple host images, an adapter card, and an LAN system made of multiple Virtual LANs (VLANs), each VLAN connected to one of the host images.

FIG. 2 is an illustration of a tagged frame used to send information in the data processing system of FIG. 1.

FIG. 3 is an illustration of the VLAN control fields of the frame of FIG. 2.

FIG. 4 is a chart showing the descriptions of the tag control fields of FIG. 3.

FIG. 5 is a chart showing the descriptions of the fields of a header which precedes the frame of FIG. 2.

FIG. 6 is a chart defining the command options of a VLAN Support request.

FIG. 7 is a chart defining the command options of a VLAN Support reply.

FIG. 8 is a chart describing the Associate VLAN request.

FIG. 9 is a chart describing the Associate VLAN reply.

FIG. 10 illustrates one example of a request format for a Start VLAN Support.

FIG. 11 illustrates an example of the SETASSTPARMS reply for VLAN support enabled.

FIG. 12 illustrates the flow between an operating system in a host and the adapter of FIG. 1.

FIG. 13 is a chart illustrating the VLAN forwarding rules for a unicast, multicast and broadcast in the data processing system of FIG. 1.

The detailed description explains the preferred embodiments of the invention, together with advantages and features, by way of example with reference to the drawings.

### DETAILED DESCRIPTION OF THE INVENTION

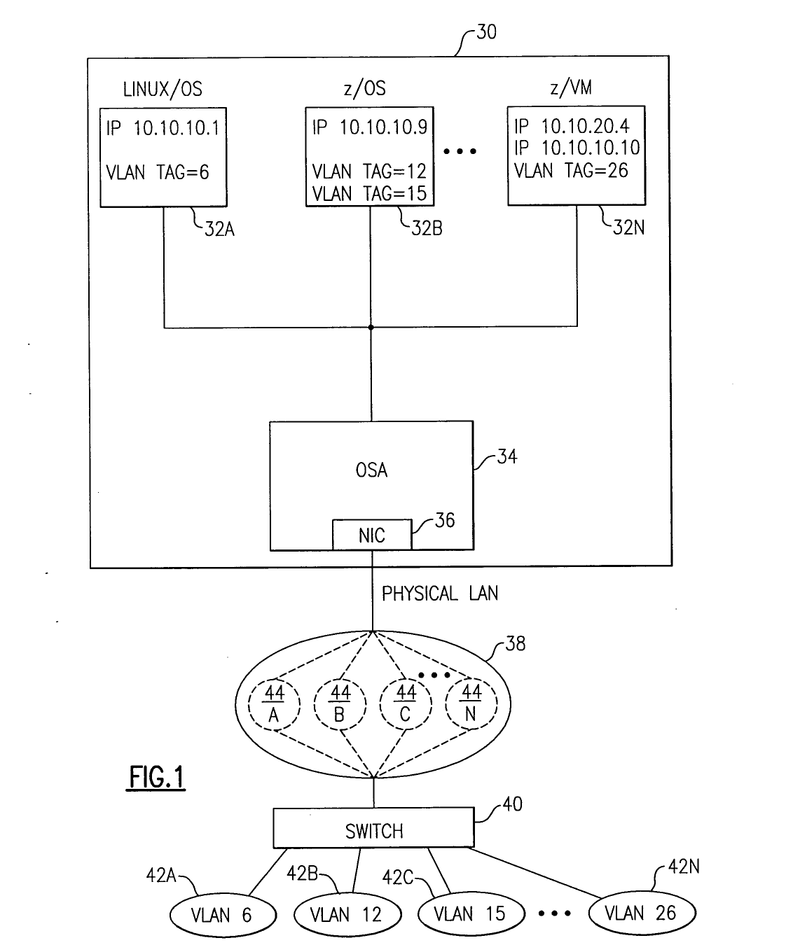

FIG. 1 is a schematic diagram of a multipartitioned Central Electronic Complex (CEC) 30 having multiple host images 32A-32N and an Open Source Adapter (OSA) 34. The OSA 34 includes a Network Interface Card (NIC) 36 connected to a physical LAN 38 which is connected to a switch 40. The switch 40 is connected to multiple VLANs 42A-42N. As is well understood, each host image 32A-32N may contain a different operating system. For instance, the host image 32A may contain a LINUX operating system, host image 32B may contain a z/OS operating system, and host image 32N may contain a z/VM operating system, or any combination of operating systems.

The present invention allows each host image 32 to connect through a single OSA 34 to its separate assigned VLAN or VLANs 42. Each host image 32 contains its own Internet Protocol (IP) address or addresses, and each host image 32 may contain one or more VLAN tags for indicating the VLAN or VLANs 42 with the host may exchange data. For instance, host image 32 A has one IP address (10.10.10.1) and one VLAN tag (6), host image 32B has one IP address (10.10.10.9) and two VLAN tags (12 and 15), and host image 32N has two IP addresses (10.10.20.4 and 10.10.10.10) and one VLAN tag 26. The present invention allows each host image 32A-32N to be connected by virtual VLAN connections to the VLANs 42A-42N. The virtual VLAN connections are shown in phantom as 44A-44N in the physical LAN 38. It will be understood that image 32A may be connected to VLAN 42A (tag 6) through 44A, image 32B may be connected to VLANs 42B and 42C (tags 12 and 15) through 44B and 44C, and image 32N may be connected to VLAN 42N (tag 26) through 44N. The present invention provides for making the described connections with a single OSA 34.

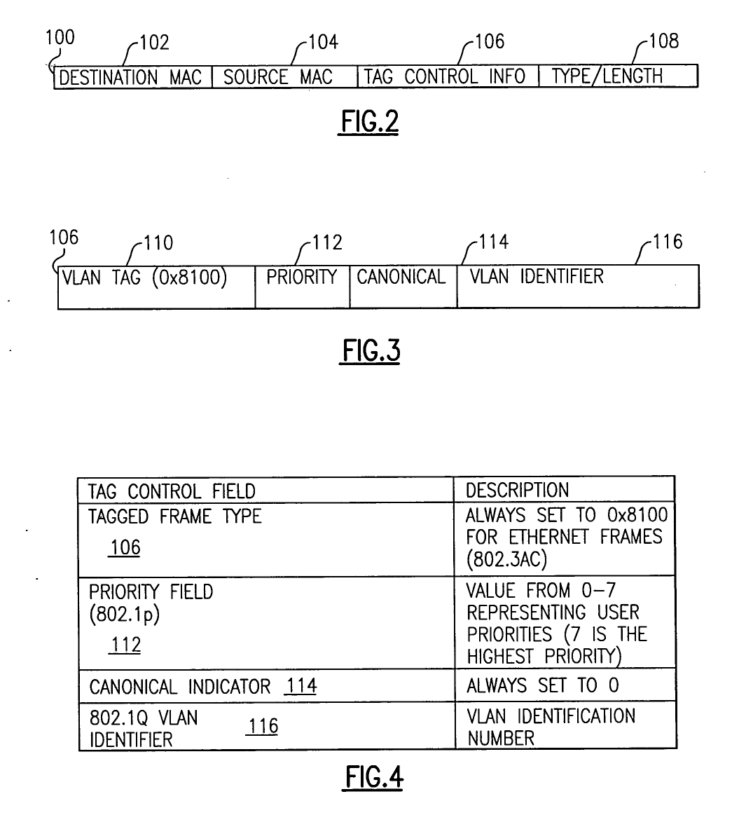

There are two types of frames in a VLAN environment. An untagged frame and a tagged frame. FIG. 2 illustrates a tagged frame 100. In FIG. 2, the tagged frame 100 includes a destination Medium Access Control (MAC) address 102, a source MAC address 104, followed by a tag header 106 which contains tag control information, and a type/length field 108. An untagged frame (not shown) is a frame that does not contain a tag header immediately following the source MAC address field of the frame or, if the frame contained a routing information field, immediately following the routing information field. A tagged frame 100 is a frame that contains a tag header 106 immediately following the source MAC address field 104 of the frame or, if the frame contained a routing information field (not shown), immediately following the routing information field.

There are two types of tagged frames: VLAN-tagged frames and priority-tagged frames. A priority tagged frame is a tagged frame whose tag header carries priority information, but carries no VLAN identification information. A VLAN-tagged frame is a tagged frame whose tag header carries both VLAN identification and priority information.

FIG. 3 is an illustration of the VLAN control information field 106 of FIG. 2. A VLAN identifier of zero is referred to a null tagged frame. Only priority information is valid for this frame. No VLAN specific information is provided. FIG. 4 is a chart which defines the tag control field definitions where the filed numbers of FIG. 3 match the definitions of FIG. 4.

Support is added to the LAN adapter shown in FIG. 1 as the OSA 34, to enable the transmitting and receipt of both tagged and untagged frames discussed. The OSA 34 specific design considerations include providing an additional bit for VLAN support. This bit is provided for in the QIPASST Bit Mask as follows:

‘00000800’X=bit 11—VLAN Support in QIPASST Bit Mask

Two commands have been added to provide for VLAN support: the VLAN SUPPORT request and the ASSOCIATE VLAN request. The command codes are as follows:

For Vlan Support

‘00000800’X—in SETASSTPARMS

For ASSOCIATE_VLAN

‘BA’X—ASSOCIATE_VLAN—associate a IP address with a VLAN Identifier

To provide the support to manage each transmitted frame on an individual basis, each frame sent from the host is preceded by the header shown in Table I.

TABLE I

| | |
|---|---|
| struct | |
| { | |
| /*----------------------------- | */ |
| /* Offset 0×00 | */ |
| /*----------------------------- | */ |

| | |
|---|---|
| BIT8 | id; |
| BIT8 | flag; |
| BIT16 | checksum; |
| BIT32 | token; |

| | |
|---|---|
| /*----------------------------- | */ |
| /* Offset 0×08 | */ |
| /*----------------------------- | */ |

| | | | |
|---|---|---|---|
| BIT16 | dg_11; | | |
| BIT8 | vlan_priority; | /* new | */ |
| BIT8 | extended_flags; | /* new | */ |
| BIT16 | vlan_priority_vlan_id; | /* new | */ |
| BIT16 | frame_offset | /* new | */ |

| | |
|---|---|
| /*----------------------------- | */ |
| /* Offset 0×10 | */ |
| /*----------------------------- | */ |

| | | |
|---|---|---|
| BIT32 v6_address[3]; | /* renamed | */ |
| BIT32 v4_address; | /* renamed | */ |

| | |
|---|---|
| } QDIO_MPC_HEADER; | |
| /*----------------------------- | */ |
| /* Header defines | */ |
| /*----------------------------- | */ |

| | |
|---|---|
| #define QDIO_HEADER_TYPE_1 | 0×01 |
| #define QDIO_HEADER_TYPE_1_SIZE | sizeof(QDIO_MPC_HEADER) |

| | |
|---|---|
| /*----------------------------- | */ |
| /* Flag defines | */ |
| /*----------------------------- | */ |

| | |
|---|---|
| #define QDIO_HEADER_FLAG_NO_CAST | 0×00 |
| #define QDIO_HEADER_FLAG_MULTICAST | 0×04 |
| #define QDIO_HEADER_FLAG_BROADCAST | 0×05 |
| #define QDIO_HEADER_FLAG_UNICAST | 0×06 |
| #define QDIO_HEADER_FLAG_ANY_CAST | 0×07 |
| #define QDIO_HEADER_FLAG_PASSTHRU_FRAME | 0×10 |
| #define QDIO_HEADER_FLAG_IPV6_FRAME | 0×80 |

| | |
|---|---|
| /*----------------------------------- | */ |
| /* extended Flag defines | */ |
| /*----------------------------------- | */ |

| | |
|---|---|
| #define QDIO_HEADER_EXT_FLAG_VLAN_FRAME | 0×01 |
| #define QDIO_HEADER_EXT_FLAG_TOKEN_ID | 0×02 |
| #define QDIO_HEADER_EXT_FLAG_INCLUDE_VLAN_TAG | 0×04 |

The definitions of the fields in the header of Table I are shown in FIG. 5.

Support for the present invention for the MVS (z/OS) and VM operating systems support a unique VLAN id per Queued Direct Input/Output (QDIO) data device. For Linux, this restriction is not applicable. OSA 34 will allow the setting of multiple unique VLAN ids per QDIO data device. OSA 34 will restrict the data device to be either VLAN enabled or not VLAN enabled. From an OSA port perspective, OSA 34 will allow both tagged and untagged frames to flow from an OSA port. Switch vendors today have there own rules on what type of tagged/untagged data they will allow flowing through one of their own ports and configuration is necessary to setup the proper forwarding and filtering rules for each port. For a unique VLAN id per data device design, the VLAN support IPA will be used with the Global VLAN id set to the VLAN identifier of the device. This identifier would be used on all outbound requests. This allows the stack to not set the VLAN id in the QDIO header for each packet. In addition, if the traffic is characterized for a unique priority, the Global priority value is set in the VLAN Support Internet Protocol Assist (IPA). In this case, all IP addresses registered on this data device will be implicitly marked with this VLAN id and will become a member of this group. As with unicast, broadcast and multicast packets coming with a VLAN tag will be subject to belonging to this VLAN. Broadcast packets would be copied to each data device that was registered to this VLAN id.

For Linux, the ASSOCIATE VLAN command associates multiple VLAN ids to a particular data device with a particular IP address. This command allows a particular IP address to be associated with multiple VLAN tags on a particular data device. It also allows a user to remove an association from a particular VLAN. In addition to providing an IP to VLAN correlation, this command is used to police certain rules for which IP address(es) belong to which VLAN(s).

On outbound, OSA 34 will support 2 modes. The setting of the VLAN tag (all 16 bits in the VLAN_PRIORITY_VLAN_IDENTIFIER field) in the QDIO header in which OSA 34 will append the proper header to the outgoing frame. The IBM QDIO architecture is well known and is disclosed in U.S. Pat. No. 6,397,350 issued May 28, 2002, hereby incorporated by reference herein. This mode is selected by setting bit 0×01 in the extended flag field). OSA 34 will also support the sending of the VLAN Tag which is already pended to the IP Frame (i.e. the first 4 bytes set in the complete VLAN tag including the 0×8100 type). Setting the 0×04 it in the extended flag field will cause OSA 34 to send this data as is, with no further tag insertion.

On inbound, the extended field VLAN bit 0×01 (QDIO_HEADER_EXT_FLAG_VLAN_FRAME), indicates a VLAN frame, is set and that the entire VLAN tag is included in the QDIO header in the V4 Address field. The using of this tag and frame information is dependent on the operating system used.

The inbound rules are as follows:

1) If a home address has a VLAN association, an inbound frame must match one of the VLANS with which this address is associated; otherwise, the frame will be discarded.

2) Broadcast and Multicast frames with VLAN tags will be propagated to those stacks that have an address with a matching associated VLAN.

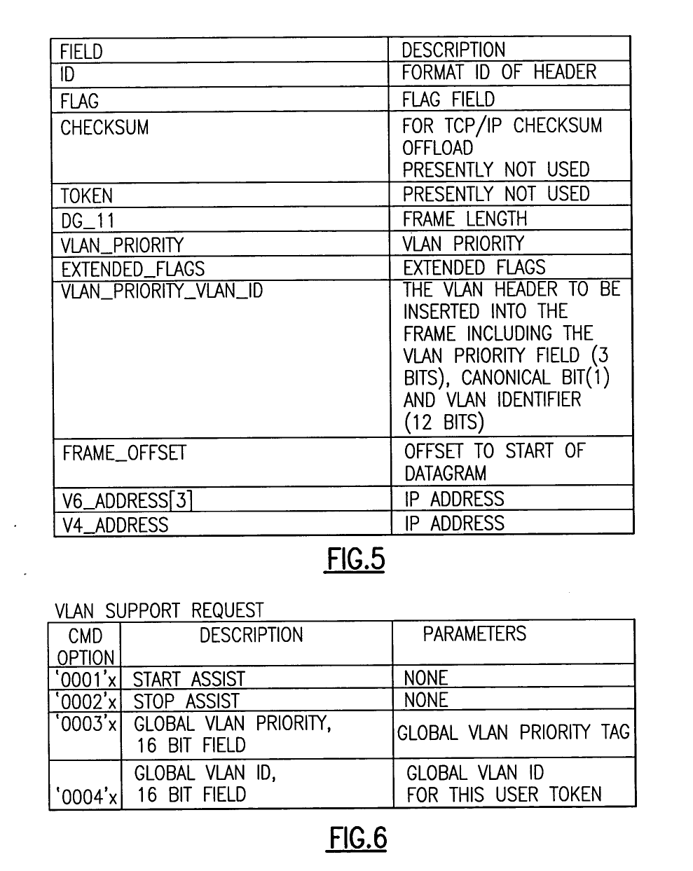

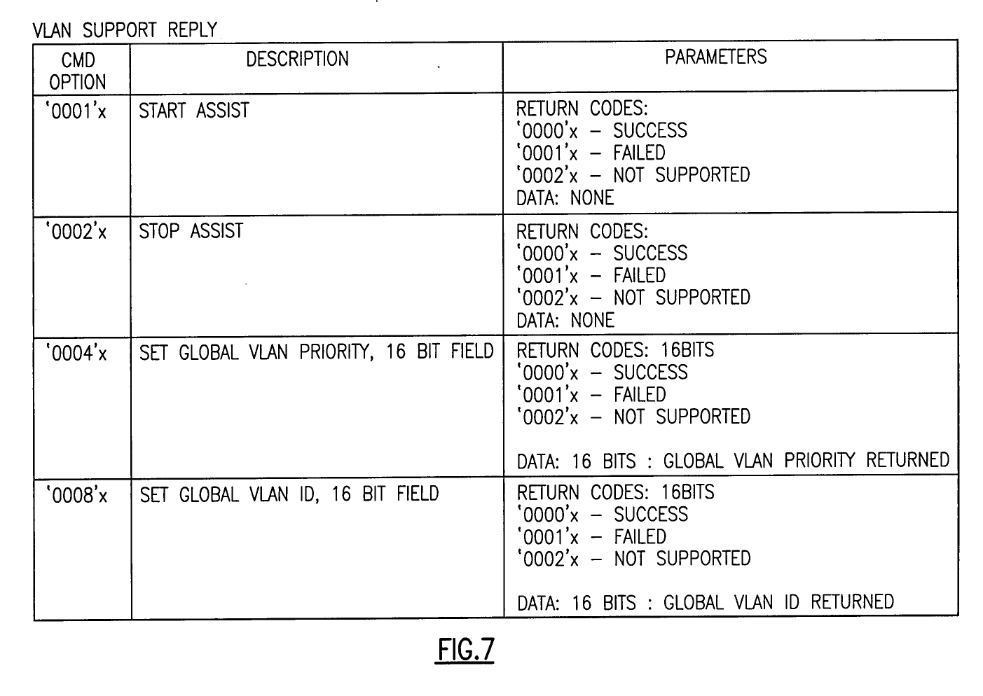

Two new commands are added to the Internet Protocol Assist (IPA) SETASSTPARMS commands to support the present invention. The IPA architecture is well known and is disclosed in U.S. Pat. No. 5,999,974 issued Dec. 7, 1999, incorporated herein by reference. The commands are the VLAN SUPPORT request and the ASSOCIATE VLAN request, and their replies. The VLAN SUPPORT request is illustrated in FIG. 6, and the VLAN SUPPORT reply is shown in FIG. 7.

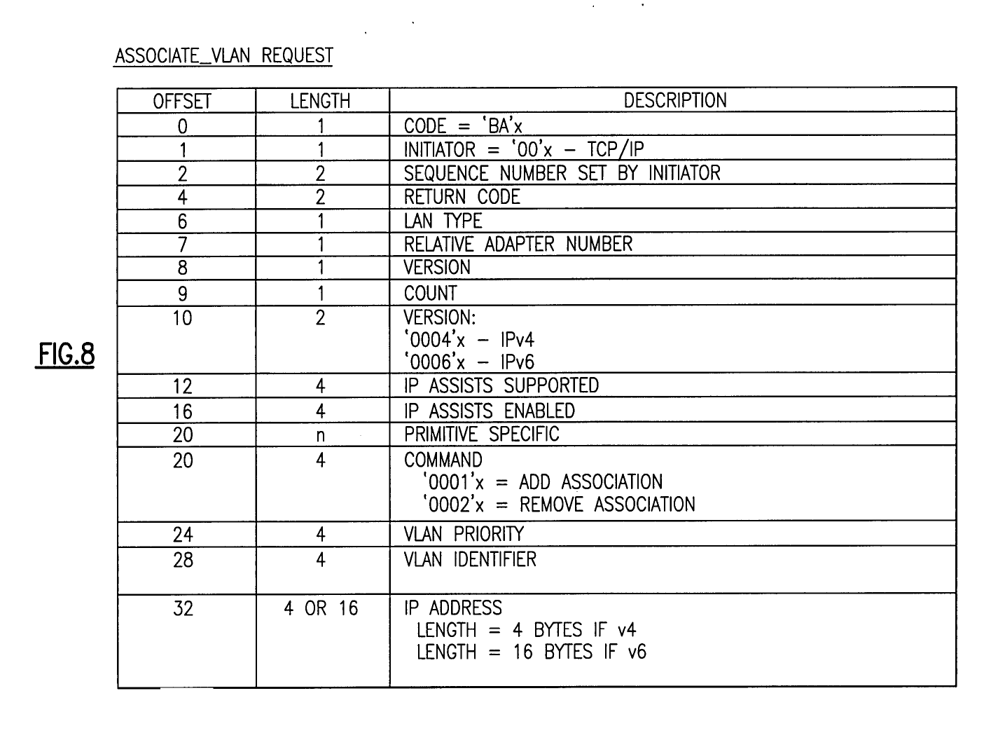

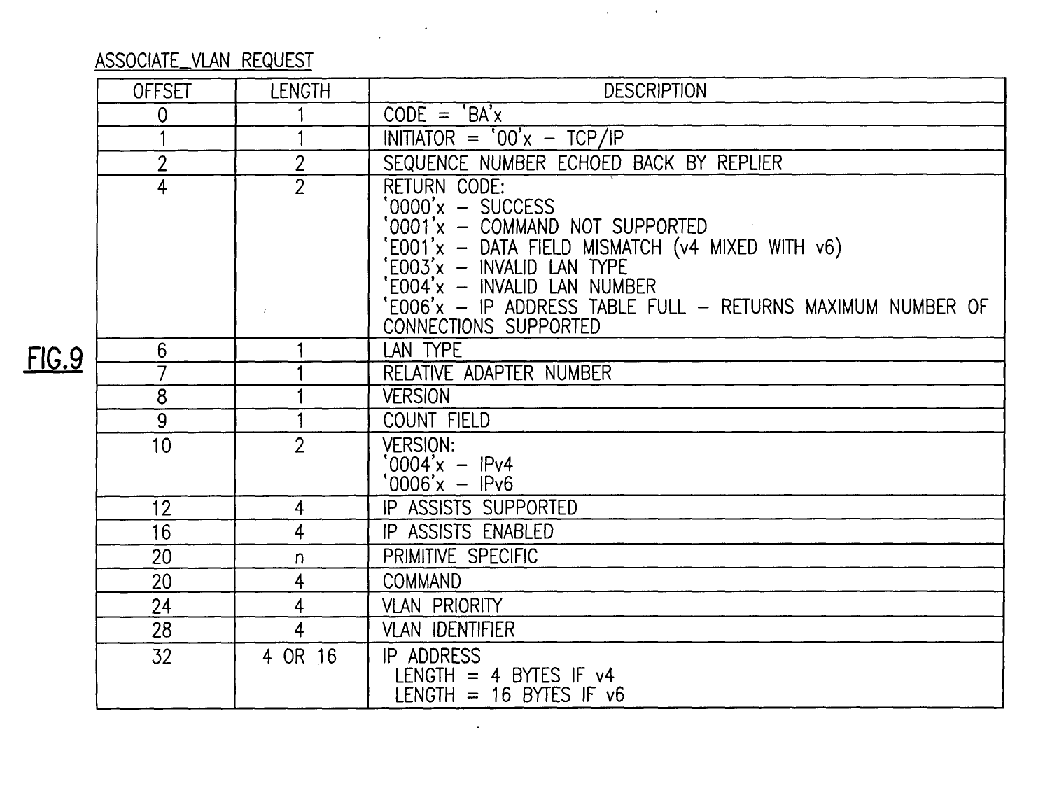

The purpose of the ASSOCIATE VLAN command is to associate a specific IP address to a specific TCP/IP user connection with a particular VLAN identifier. The OSA 34 associates the individual sessions with the tokens used to establish the Multipath Channel (MPC) or QDIO connection. When receiving frames from the LAN, the device driver on the OSA card must be able to correlate the IP address in the IP data gram to the proper IP user session/VLAN Id Association so the correct token can be specified when routing received packets to TCP/IP instances on the 390. The ASSOCIATE VLAN request is shown in FIG. 8, and the ASSOCIATE VLAN reply is shown in FIG. 9.

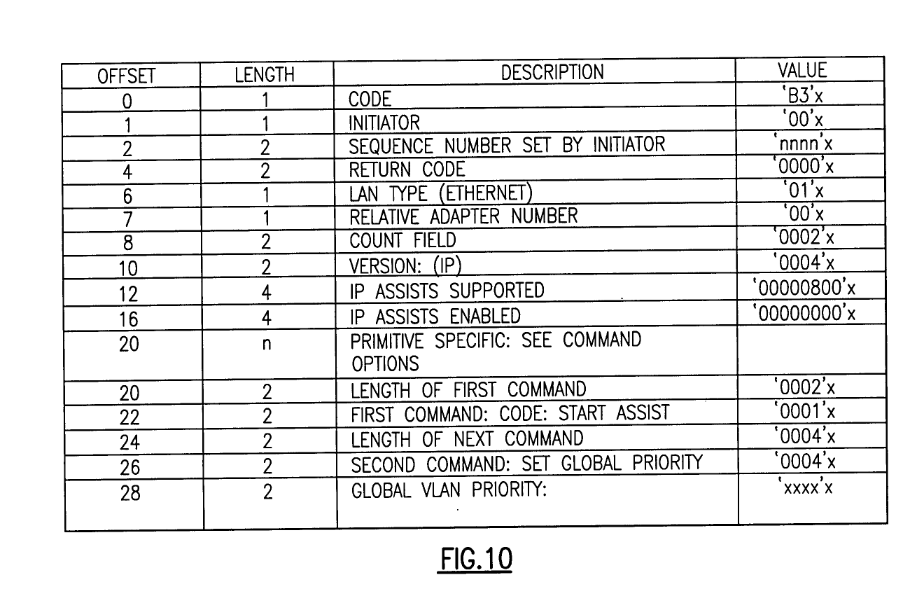

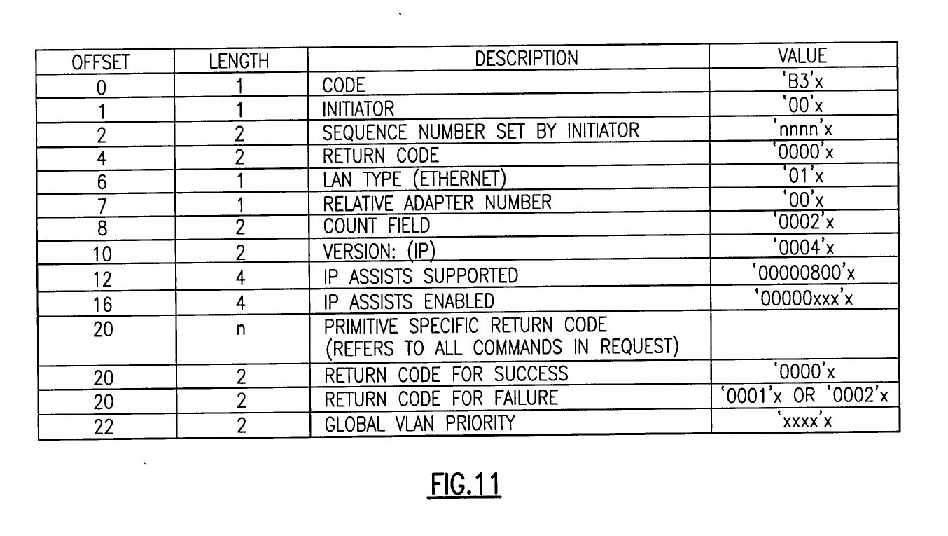

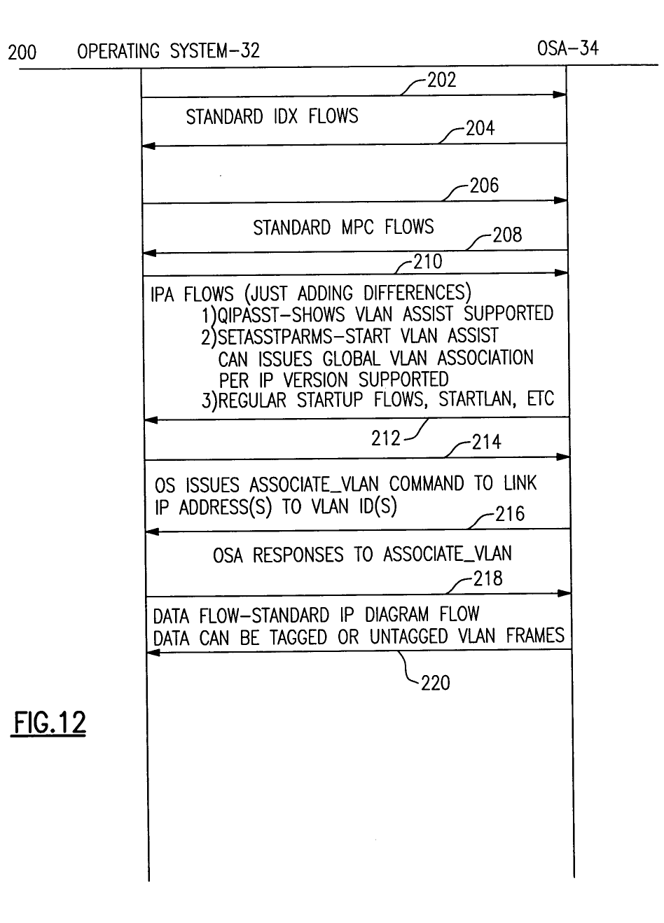

To further understand the invention, FIG. 10 illustrates an example request format for the Start VLAN Support. FIG. 11 is an example of the SETASSTPARMS reply for VLAN Support Enabled which is the response for the request of FIG. 10.

FIG. 12 illustrates the VLAN flow for the present invention. At 200 an operating system, such as an operating system shown in one of the host images 32 of FIG. 1, is represented. As is well known, standard IDX flows are exchanged at 202 and 203 between the operating system in 32 and the OSA 34 of FIG. 1. MPC flows are exchanged at 206 and 208 between the operating system in 32 and the OSA 34. MPC provides a highly efficient data transfer interface which is implemented in the VTAM layer. MPC uses a blocked data stream called Discontiguous Protocol Data Units (PDUs). This data stream allows the header or control information to be separate from the user data. MPC then transmits the data onto the channel in one CCW stream. This eliminates the memory move which was necessary in the LAN Channel Station (LCS) protocol and required the header and data portions to be in a Contiguous PDU. The Upper Layer Protocols (ULPs) which process the user data can now build the headers in a separate memory area and pass VTAM the pointer to the header information and a separate pointer to the user data area. MPC will place the headers in the PDU header which will be part of the first segment transferred. The user data is placed in the PDU data section which is transferred to the OSA adapter 34 as one Contiguous block of data. IDX exchanges are part of the MPC transport support for VM, z/OS, and Linux.. At 210 and 212, Internet Protocol Assist (IPA) flows are made. These IPA flows include:

1) QIPASST to show that VLAN Assist is supported;

2) SETASSTPARMS to start VLAN Assist, and may issue GLOBAL VLAN association per IP version supported; and

3) Regular startup flows such as STARTLAN, etc.

At 214, the operating system in 32 issues the ASSOCIATE VLAN command to link IP address(es) to the VLAN id(s). At 216, the OSA 34 responds with an ASSOCIATE VLAN reply. At 218 and 220, data flow takes place with the standard IP datagram flow in tagged or untagged VLAN frames (see FIG. 2).

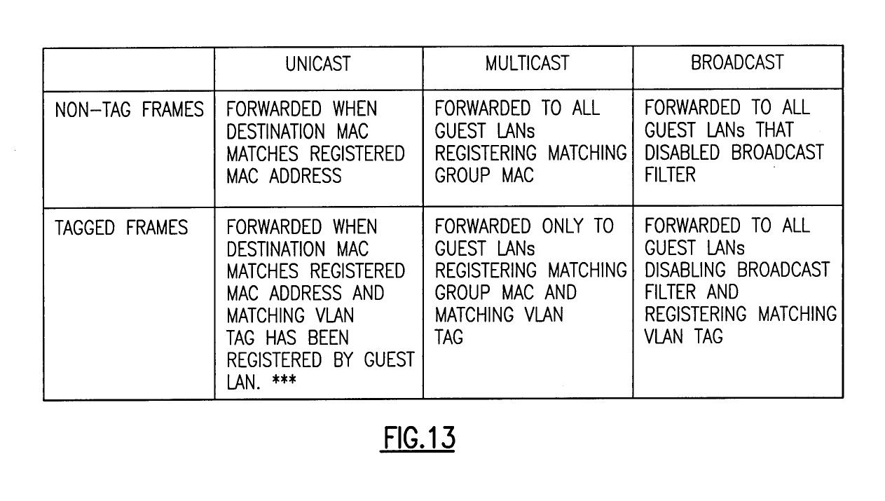

The table of FIG. 13 summarizes the rules which will be used for routing inbound packets when a VLAN Tag is present and when it is not. These rules try to match the well known rules for the switch 38. Each Guest LAN can register more than one VLAN Tag and the same VLAN Tag will be allowed to be registered by more than one Guest LAN.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A data processing system comprising:
a host computer having a memory partitioned into multiple logical partitions, each partition having an operating system for processing data;
an adapter in said host computer;
multiple virtual local area networks (VLANs) for exchanging data with said partitions of said host computer; and
an Internet Protocol Assist (IPA) layer in said host computer having an ASSOCIATE VLAN for associating said VLANs with said partitions such that an individual partition may exchange data with one or more VLANs. .

2. The data processing system according to claim 1 wherein each of said partition in said host computer has one or more Internet Protocol (IP) addresses, and said IPA layer has aVLAN SUPPORT command for providing said IP addresses of said partitions to said adapter such that said ASSOCATE VLAN command associates the IP addresses of said partitions with said VLANs.

3. The data processing system according to claim 1 wherein said IPA layer provides for unicast, multicast and broadcast operations between said partitions and said VLANs.

4. In a data processing system including a host computer having a memory partitioned into multiple logical partitions, each partition having an operating system for processing data, an adapter and multiple virtual local area networks (VLANs) for exchanging data with said partitions of said host computer, a method comprising:
providing an Internet Protocol Assist (IPA) layer in said host computer; and
associating with an ASSOCIATE VLAN command in said IPA layer, VLANS and said partitions such that an individual partition may exchange data with one or more of said VLANs.

5. The method according to claim 4 further comprising:
providing each of said partition in said host computer with one or more Internet Protocol (IP) addresses; and
providing with a VLAN SUPPORT command, said IP addresses of said partitions to said adapter such that said ASSOCATE VLAN command associates the IP addresses of said partitions with said VLANs.

6. The method according to claim 5 further comprising providing with said IPA layer, unicast, multicast and broadcast operations between said partitions and said VLANs.

7. A program product for use in a data processing system including a host computer having a memory partitioned into multiple logical partitions, each partition having an operating system for processing data, an adapter and multiple virtual local area networks (VLANs) for exchanging data with said partitions of said host computer, said program product comprising:
a computer readable medium having recorded thereon computer readable program codr for performing the method comprising:
assigning VLAN identifications to said VLANS; and
associating said VLAN identifications with said partitions such that an individual partition may exchange data with one or more of said VLANs.

8. The program product according to claim 7 wherein said method comprises:
assigning each of said partition in said host computer with one or more Internet Protocol (IP) addresses; and
associating said IP addresses of said partitions with said VLANs.

9. The program product according to claim 8 wherein said method comprises:
providing unicast, multicast and broadcast operations between said partitions and said VLANs.
